(19) United States
(12) Patent Application Publication
(10) Pub. No.: US 2009/0128354 A1
(43) Pub. Date: May 21, 2009

(54) POWER SUPPLY FOR PROVIDING AN INTERNAL POWER SUPPLY VOLTAGE

(75) Inventors: RICHARD SBUELL, Graz (AT); Walter Kargl, Graz (AT); Albert Missoni, Graz (AT)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/942,375

(22) Filed: Nov. 19, 2007

(51) Int. Cl. G08B 1/08; G05F 1/10

(52) U.S. Cl. 340/693.4; 323/223

(57) ABSTRACT

A power supply for providing an internal supply voltage, the power supply including a current source configured to provide an internal supply voltage directly from its output, and a high speed internal supply voltage shunt, which is coupled to the current source output.

### BACKGROUND OF THE INVENTION

The present invention is directed generally to a power supply for providing an internal power supply voltage, and more particularly to a contactless card having a power supply with an internal power supply (VDD) regulator integrated with a decoupling module.

The basic components of a contactless card system are a contactless reader and the contactless card. The contactless reader, also known as a PCD, includes an antenna electrically coupled to an electronic circuit. The contactless card, also known as a smart card, a tag, a PICC, or an RFID tag, has an inductive antenna and an integrated circuit electrically coupled to the inductive antenna.

When the contactless card penetrates a transmission field of the reader, the reader antenna transmits to the contactless card a carrier signal, which generates a radio frequency (RF) field to supply the contactless card with power, and data, which is achieved by amplitude modulation of the carrier signal. In return, the contactless card transmits data by load modulating the carrier signal. This load modulated signal is detected by the reader antenna. The communication between the reader and the contactless card may be defined by any of numerous ISO (International Organization for Standardization) standards, such as 14443 Type A/B/C, 15693, 18000, etc.

FIG. 2 shows a circuit diagram 200 of a portion of a contactless card in which VDD regulation and a decoupling circuit are separate modules.

When the contactless card penetrates a transmission field, the field induces a voltage in antenna 210. The induced voltage is then multiplied by a series resonant circuit including antenna inductance and external tuning capacitor 220. The series resonant circuit output voltage at node VLA/LB is the voltage at chip-load independent antenna-interface 230, and is limited to 4-5V by field shunt 240. When there is a detuned, weak field, the voltage at node VLA/LB decreases to approximately 3V, and in such a case, field shunt 240 will not shunt any current.

Main rectifier 250 rectifies the voltage at node VLA/LB. The voltage drop of main rectifier 250 is about 1V in a case of low output current. The voltage at node VDDRF, which is at the output of main rectifier 250, is therefore approximately 3-4V. VDDRF voltage capacitor 260 reduces ripple in the voltage at node VDDRF.

Decoupling module 270 is coupled to the output of main rectifier 250 at node VDDRF, and includes main current source 272, VDDMID shunt 276, and VDDMID capacitor 274. Current source 272 decouples node VDDRF from node VDDMID, which is located at the output of decoupling module 270. VDDMID shunt 276 limits the voltage at node VDDMID to approximately 2.2V to thereby obtain sufficient voltage margin (from node VDDMID to node VDD) for VDD regulator 282, whose output voltage equals, for example, 1.5V. VDD regulator module 280 is coupled to the output of decoupling module 270. VDD regulator module 280 is coupled to the output of decoupling module 270. VDD regulator module 280 includes VDD regulator 282 and VDD voltage capacitor 284, which is coupled to the output of VDD regulator 282 and reduces ripple in the internal power supply voltage VDD.

In order to decouple node VDDRF from the “spiky” node VDDMID, current source 272 needs to be saturated, and thus the drain-to-source voltage of current source 272 should at least equal to 500 mV. This results in the minimum voltage at node VDDRF for decoupling node VDDRF from node VDDMID being approximately 2.7V. As a result the minimum voltage at node VLA/LB, taking into consideration the main rectifier voltage drop, is approximately 3.7V. Thus, the minimum antenna voltage for providing a chip-load independent antenna interface must be at least approximately 3.7V. In a case of a detuned serial resonant circuit and weak field, the antenna voltage drops down to approximately 3V. A weak field does not necessarily imply a large distance between the contactless card antenna 210 and the reader antenna (not shown). In low power reader environments, the field strength supplied to the contactless card by the reader is very low, even if the card antenna 210 and the reader antenna are well coupled. As a result, current spikes are also coupled to the demodulator circuit of the reader resulting in a decreased signal-to-noise ratio.

### BRIEF DESCRIPTION OF THE DRAWINGS

FIG. 1A is a circuit diagram of a portion of a contactless card including an integrated VDD regulator according to an embodiment of the present invention;

FIG. 1B is a circuit diagram of a high speed VDD shunt according to an embodiment of the present invention; and

FIG. 2 is a circuit diagram of a portion of a contactless card.

### DETAILED DESCRIPTION OF THE INVENTION

The present invention is directed generally to a power supply for providing an internal power supply voltage, and more particularly to a contactless card with a chip-load independent antenna interface and having an internal power supply (VDD) regulator integrated with a decoupling module.

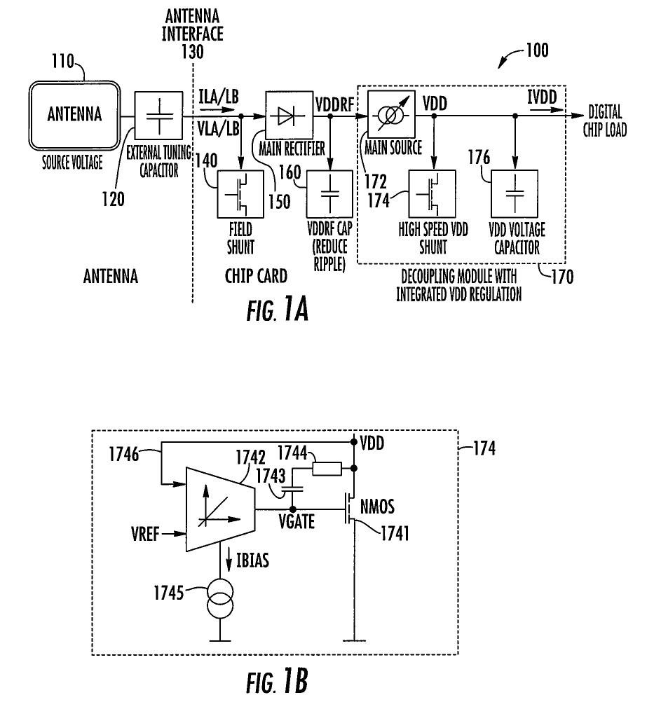

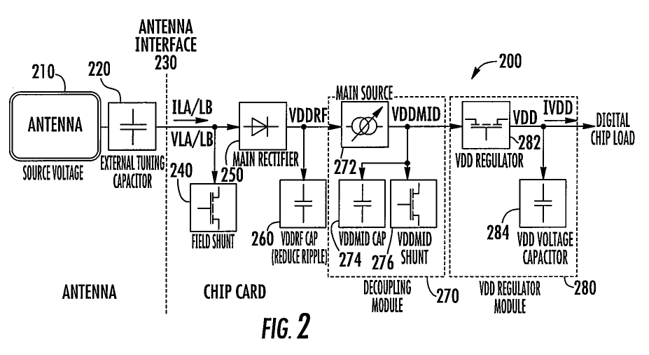

FIG. 1A shows a circuit diagram 100 of a portion of a contactless card including an integrated VDD regulator according to an embodiment of the present invention. The circuit diagram 100 includes an antenna 110 and an external tuning capacitor 120 on one side of antenna interface 130. On the other side of the interference 130 there is field shunt 140, main rectifier 150, VDDRF capacitor 160, and decoupling module with integrated VDD regulation 170. In the description below, VDD at times refers to the internal power supply voltage, but can also refer to the node at which the internal power supply voltage may be found.

When the contactless card penetrates a transmission field, the field induces a voltage in antenna 110. The induced voltage is then multiplied by a series resonant circuit including antenna inductance and external tuning capacitor 120. The series resonant circuit output voltage, located at node VLA/LB at antenna interface 130, is limited by field shunt 140, preferably to approximately 4-5V. When there is a detuned, weak field, the voltage at node VLA/LB decreases to approximately 3V, and in such a case, field shunt 140 will not shunt any current. Main rectifier 150 rectifies the voltage at node VLA/LB, and VDDRF voltage capacitor 160 reduces ripple in the rectified voltage at node VDDRF.

Decoupling module with VDD voltage regulation 170 is coupled to node VDDRF at the output of the main rectifier 150. Decoupling module 170 includes main current source 172, a high speed VDD shunt 174 coupled to the output of current source 172. VDD voltage capacitor 176 is also coupled to the output of current source 172, and reduces ripple in the internal power supply voltage VDD.

By integrating VDD voltage regulation into the decoupling module 170, node VDDMID becomes node VDD, that is, current source 172 provides the internal supply voltage VDD directly from its output. The internal supply voltage at the output node VDD of the current source 172 can be reduced, for example from 2.2V to 1.5V, and still be able to decouple the antenna interface in a low power reader environment with a detuned contactless card antenna resonant circuit. This is because when internal supply voltage at the output node VDD is 1.5V, the minimal voltage at node VDDRF is therefore approximately 2V, as the voltage drop at the current source is approximately 500 mV. Considering the voltage drop across main rectifier 150, the minimum voltage at node VLA/LB is therefore approximately 3V. As a result, decoupling of the antenna interface is possible in a low power reader environment with a detuned contactless card antenna resonant circuit. Also, the operating voltage of the system is decreased by about 300-400 mV.

It is understood that the current source 172 providing the internal supply voltage VDD from its output directly means that there are no active elements, e.g., a regulator, coupled between the current source 172 and the node VDD. However, it is possible that a series passive element could be coupled between the current source 172 and the node VDD, and the current source 172 would still be considered to be outputting the internal supply voltage VDD directly.

FIG. 1B shows a circuit diagram of high speed shunt 174 according to an embodiment of the present invention. High speed VDD shunt 174 is included in the decoupling module 170 to overcome some negative effects of coupling node VDD being located directly at the output of current source 172. These effects may include a degradation of the internal power supply at node VDD. Additionally, large internal power supply load changes, for example, 100 uA-15 mA, must be directly handled by the decoupling module 170; if there is a load step from 100 uA to 15 mA lasting 60 ns, the internal power supply voltage drop should be smaller than 100 mV. Further, during a transmission field pause, the contactless card is not supplied with energy. In such a case the high speed VDD shunt 174 should fully turn off in order to maintain the current consumption at node VDD to a minimum.

High speed shunt 174 basically comprises NMOS transistor 1741, high speed control circuit 1742, capacitor 1743, resistor 1744, and current source 1745. Control circuit 1742 compares the actual internal supply voltage at node VDD with a reference voltage VREF, and controls the gate voltage VGATE of the shunt transistor 1741 such that the internal supply voltage at VDD equals the reference voltage VREF. To stabilize this high speed regulation loop, the drain of the shunt transistor 1741 is coupled to its gate by a resistor 1744 coupled in series with a capacitor 1743. Current source 1745 controls a bias current of control circuit 1742. In one embodiment, control circuit 1742 is implemented using an operational amplifier and shunt transistor 1741 is a current source.

The various operating conditions or load steps can be easily handled by this high speed VDD shunt 174. During a transmission field pause, the chip is not supplied with energy. In such a case the NMOS shunt transistor 1741 is turned off completely to save current. More specifically, during the pause the internal supply voltage VDD drops slightly below the reference voltage VREF, the voltage at the gate of the shunt transistor 1741 is pulled down, and the shunt transistor 1741 fully turns off. As a result, no current is shunted by the NMOS shunt transistor 1741 during the pause. Additionally, the control loop 1746 pulls up the gate voltage of the NMOS shunt transistor 1741 quickly at the rising edge of the transmission field pause, to thereby avoid internal supply voltage VDD overshoots.

The integration of the internal power supply VDD regulator into the decoupling module of a contactless card with a chip-load independent antenna interface dramatically reduces chip area and additionally reduces the minimal antenna interface voltage (VLA/LB) required for proper functioning of the decoupling module.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A power supply for providing with an internal supply voltage, comprising:
a current source configured to provide an internal supply voltage directly from its output; and
a high speed internal supply voltage shunt, which is coupled to the current source output.

2. The power supply of claim 1, wherein the high speed internal supply voltage shunt is configured to shunt current at the current source output when the internal supply voltage is at least substantially equal to a reference voltage.

3. The power supply of claim 1, wherein the high speed internal supply voltage shunt comprises:
an NMOS transistor;
a high speed control circuit connected to the gate of the NMOS transistor, wherein the high speed control circuit is configured to compare the internal supply voltage with a reference voltage, and to control the gate voltage of the shunt transistor such that the internal supply voltage equals the reference voltage.

4. The power supply of claim 3, wherein the high speed internal supply voltage shunt further comprises a resistor in series with a capacitor coupled between the drain and the gate of the NMOS transistor.

5. The power supply of claim 1, further comprising an internal supply voltage capacitor coupled to the current source output.

6. The power supply of claim 1, wherein during a field pause the high speed internal supply voltage shunt is off.

7. The power supply of claim 3, wherein the high speed control circuit is an operational amplifier.

8. The power supply of claim 1, wherein the power supply provides the internal supply voltage to a contactless card.

9. A power supply for providing a contactless card having a load independent antenna interface with an internal supply voltage, comprising a decoupling module having an integrated VDD regulator.

10. A contactless card comprising:
a current source configured to provide the contactless card with an internal supply voltage directly from the current source output; and
a high speed internal supply voltage shunt, coupled to the current source output, and configured to shunt current at the current source output when the internal supply voltage is at least substantially equal to a reference voltage.

11. A method for providing an internal supply voltage, comprising:
providing the internal supply voltage directly at an output of a current source;
comparing the internal supply voltage with a reference voltage; and
turning off a high speed shunt so that no current is shunted from the output of the current source when the internal supply voltage is less than the reference voltage.

12. The method of claim 11, wherein the internal supply voltage is provided to a contactless card.

13. A power supply for providing an internal supply voltage, comprising:
a current means for providing an internal supply voltage directly from its output; and
a voltage shunt means, which is coupled to the current means output, for comparing the internal supply voltage with a reference voltage so that no current is shunted from the output of the current means when the internal supply voltage is less than the reference voltage.

14. The power supply of claim 13, wherein the voltage shunt means comprises:
an NMOS transistor; and
a high speed control circuit coupled to the gate of the NMOS transistor.

15. The power supply of claim 14, wherein the high speed control circuit is an operational amplifier.

16. The power supply of claim 14, wherein the voltage shunt means comprises a resistor in series with a capacitor coupled between the drain and the gate of the NMOS transistor.

17. The power supply of claim 13, wherein the power supply provides the internal supply voltage to a contactless card.
